(19) United States
(12) Patent Application Publication
(10) Pub. No.: US 2022/0164503 A1
(43) Pub. Date: May 26, 2022

(54) COMPUTATIONAL ENGINEERING DESIGN FRAMEWORK METHOD & SYSTEM

(71) Applicant: Parikshat Singh, London (GB)

(72) Inventor: Parikshat Singh, London (GB)

(21) Appl. No.: 17/602,714

(22) PCT Filed: Apr. 14, 2020
(86) PCT No.: PCT/GB2020/050946

§ 371 Date: Oct. 8, 2021

(30) Foreign Application Priority Data
Apr. 12, 2019 (GB) 1905262.0

(51) Int. Cl. G06F 30/28; G06F 30/15

(52) U.S. Cl. CPC G06F 30/28; G06F 2111/04; G06F 30/15

(57) ABSTRACT

The present disclosure relates to a method and software for creating engineering designs using a computational framework and particularly, but not exclusively, to software to enable experts, including designers and engineers, and non-experts to build entire engineering designs from digital modular components and features so as to create designs and models of designs for physical objects and structures, for example including but not limited to geometric models and/or thermodynamic models, relatively quickly, easily and substantially accurately and can enable designs of higher complexity that possible with traditional approaches. Aspects and/or embodiments seek to provide a method and system enabling experts and non-experts to design substantially dynamic/adaptable system architectures, by using a computational framework, from which CAD models, design drawings and other engineering information such as semantics, geometry, thermodynamics or electrical (among others) for the design/architecture can be generated and can allow a user to explore entire design spaces. Aspects and/or embodiments can also seek to provide that experts and non-experts use a computational framework to describe the engineering process such that the execution is performed to generate the final designs automatically and repeatably.

### FIELD

The present disclosure relates to a method and software for creating engineering designs using a computational framework and particularly, but not exclusively, to software to enable experts, including designers and engineers, and non-experts to build entire engineering designs from digital modular components and features so as to create designs and models of designs for physical objects and structures, for example including but not limited to any or any combination of geometric models and/or thermodynamic models (among other types of model), relatively quickly, easily and substantially accurately and can enable designs of higher complexity that possible with traditional approaches.

### BACKGROUND

Engineering design is a complex process requiring teams of engineers and designers to first prepare specifications for complex products and solutions, then prepare one or more conceptual designs and finally produce one or more sets of detailed design drawings. This same approach to engineering design is used in a variety of fields such as civil, mechanical, electrical, chemical, aerospace, structural and nuclear engineering disciplines among others.

Typically, the aforementioned engineering design process involves a sequence of phases, which are broadly as described in the following steps:

1. In the first phase, a specification (functional, aesthetic or otherwise) is prepared that outlines what needs to be done and a set of outline requirements—for example a payload having certain characteristics (e.g. a certain size or weight, or range of sizes or weights) needs to be transported in some way (e.g. between two points, or between places up to a certain distance apart, or into the Earth's atmosphere).

2. Then follows the phase known as concept development. What is typically called an architecture is prepared, the architecture setting out an outline design that aims to meet the outline requirements/specification. The architecture is usually created by experienced engineers using their experience and rules of thumb to provide an outline design based on what has worked before, what their experience has taught them might work, and existing designs or design elements. The further away from the body of existing engineering knowledge the requirements are, the more of a guess the architecture that ends up being proposed can be. Up until this point is about 5% of the work involved in the entire process.

3. Optionally, some modelling of parts or all of the architecture are performed using either manual calculations, typical spreadsheet software or sometimes using specialist software tools.

4. In addition, or instead, old data or design elements are obtained that might be able to be re-used or adapted for the current architecture or requirements.

5. In parallel, very rough conceptual computer-aided design (CAD) designs/models may be produced to outline the aesthetics of the design, for example to produce (options for) designs for shapes or specific elements of the likely eventual design.

6. From the architecture, and sometimes based on modelling/old data/previous designs, the conceptual design is turned into a set of early stage designs, usually CAD models produced using CAD tools.

7. Optionally, some iterations of the design documents can be prepared. For example, some parts or all of the detailed design documents may then be prototyped and/or modelled and, if needed, amendments can be made to the detailed design documents to more closely meet the outline requirements in the specification.

8. Then, the detailed design development requiring about 95% of the work involved in the entire process is carried out. This is when interfaces are agreed for the detailed design, typically by agreements between each of the specialised teams within the whole engineering team, in order to aim for the architecture as an output for the team to design towards, and to enable each specialised team to develop (or reuse) mathematical and geometry models to reach a detailed design of the portion for which they are responsible. This step also involves a large number of iterations in order to reach a conclusion.

9. A final set of design documents are then produced (which may not always meet the requirements exactly, but is usually a working design for a product/solution).

Engineers and designers rely heavily on a wide variety of non-integrated tools and techniques, including: computer aided design software packages (CAD), spreadsheets, simulation software packages, engineering tables, rules of thumb and standards. While CAD software has replaced physical drafting of engineering drawings and design documents with a process that can be performed on a computer, which has reduced the costs incurred and time spent on producing and editing design documents, the complete set of tools and techniques are fragmented so significant amounts of time and cost are spent obtaining these tools, learning these tools and techniques, and thus time is lost to the inefficiencies of learning, combining and using these tools and techniques.

In addition, any optionally produced CAD designs are only ever illustrations of a system, typically without any complete semantic meaning and without even an attempt to fully detail any aspect of the design(s) other than geometry.

It is a known problem that the design capabilities in many industries are restricted to the use of the aforementioned iterative design processes and semantic information has to be transferred manually/inefficiently between tools, models and/or people during the design process. Further, current approaches typically produce sub-optimal, or unintended but feasible, designs or solutions. Also, cost, size and geometric models are typically generated empirically and so without a clear direction relation to the parameters or properties of the product or solution being designed, for example the internal thermodynamic properties or functions might be considered but the chosen design aspects relating to these properties or functions are not guaranteed to have any directly attributable connection back through the design process to the initial requirements.

Although attempts are being made to build computer augmented design processes, such as the Autodesk® “Generative design” software, these processes are limited in scope, and typically limit the user to selecting one of many computer designed outputs from constraints input by a user.

The terminology used in the following description should be interpreted as follows:
(a) “requirements” is used to describe the target, outline or initial requirement;
(b) “specification” is used to describe the documentation that sets out in more detail the technical characteristics of the requirements and any relevant design information or constraints;
(c) “design” can be taken to refer to the realisation of a concept or idea into a configuration, drawing or model;
(d) “architecture” is used to describe an outline or conceptual design, i.e. a design that is very high level and does not yet have the full detail incorporated;
(e) “semantics” is used to describe the meaning, reasoning, or know how behind why a design decision was made, or the choice of any functional interrelation of parts or features of a design;
(f) “CAD models” or “CAD designs” are used to describe digital 3D models or plans produced using computer-software tools;
(g) “detailed design” is a design having the full detail determined and incorporated such that CAD models can be produced for the design; and
(h) “design drawings” or “drawings” means the 2D drawings that are typically output from a CAD model or design

### SUMMARY OF INVENTION

Aspects and/or embodiments seek to provide a method and system enabling experts and non-experts to design substantially dynamic/adaptable system architectures, by using a computational framework, from which CAD models, design drawings and other engineering information such as semantics, geometry, thermodynamics or electrical (among others) for the design/architecture can be generated and can allow a user to explore entire design spaces. Aspects and/or embodiments can also seek to provide that experts and non-experts use a computational framework to describe the engineering process such that the execution is performed to generate the final designs automatically and repeatably.

Specifically, aspects and/or embodiments outline a new design process to model a design or design space, where optionally the design or design space should not require subsequent iterations or refinement to reach a solution if all of the design inputs, parameters and choices have been input and/or made respectively. In aspects and/or embodiments, the process can involve the engineer having to build small, re-usable, and abstractable building blocks to precisely define a design. In some aspects/embodiments, some or the design inputs/parameters/choices are not fully specified in order to allow the design space to be explored by users and/or to allow for some or all of these design inputs/parameters/choices to be determined, generated or chosen, for example through use of an optimisation process.

According to a first aspect, there is provided a method for determining a plurality of properties for one or more component designs, the method comprising the steps of: receiving one or more inputs relating to each of the one or more component designs; and determining one or more relationships between the one or more inputs for the one or more component designs.

Determining a plurality of properties for one or more component designs by determining (or using known) relationships between inputs and/or outputs and/or properties relating to the one or more component designs can provide a method to produce designs for components/parts/architecture(s) quickly based on input data. By using the computational framework it can be possible to find the substantially ideal properties and/or deterministic architecture for a set of design inputs.

Optionally, the plurality of properties defines one or more semantic properties and one or more geometric properties.

In some embodiments, defining the semantic and geometric properties can provide sufficient information for a design to be substantially automatically generated based on the inputs.

Optionally, the one or more component designs comprises any one or more of: schema; architecture; and/or output design.

In some embodiments, the component designs can be one or more of a number of different types of design.

Optionally, the one or more inputs comprise any one or more of: architectural inputs; composing inputs; relational inputs; and/or constraining inputs. Optionally, the one or more inputs comprises one or more semantic and/or geometric inputs comprising any one or more of: architectural inputs; composing inputs; relational inputs; and/or constraining inputs.

In some embodiments, different inputs can be used to generate the design(s) using the method according to any aspect.

Optionally, the one or more relationships is (further) determined based on the architectural inputs and the composing inputs; optionally wherein the one or more relationships comprise semantic and/or geometric relationships.

In some embodiments, the inputs can include architectural and composing inputs. In some embodiments, the relationships (for example between the parts or elements of the design) can be semantic or geometric.

Optionally, the architectural inputs comprise any one or a combination of: primitives, pre-determined architectures; newly defined architectures; architecture functions; geometry; and/or a bounding function.

In some embodiments, the architectural inputs can be a variety of inputs or a combination of these, including primitives, pre-determined architectures; newly defined architectures; architecture functions; geometry; and/or a bounding function.

Optionally, the composing inputs comprise one or more interfaces between the one or more component designs; optionally wherein the one or more interfaces comprises any one or more of: attaching; fixing; bolting; clipping; gluing; rotating; supporting; welding; clearing; fitting; sliding; contacting; relative or absolute positioning; limiting movement in one or more degrees of freedom; enabling movement in one or more degrees of freedom; torque transfer; force loading; magnetic coupling; meshing; spacing; friction; piping; connecting; linking; heat transfer; pressure flow; and/or flow.

In some embodiments, the composing inputs can be one of a number of interfaces between parts/elements of a design/architecture. This can enable the creation of the architectural design space.

Optionally, the constraining inputs comprise any one or more constraint values relating to each of the one or more component designs; optionally comprising data; regulations; objective functions; geometry; special relationships; manufacturing constraints; design constraints; rules of thumb; and/or values.

In some embodiments, the constraining inputs can reduce the design space (i.e. reduce the number of potential output representations and/or designs).

Optionally, the characteristics of the plurality of properties comprise any one or more of semantic and/or one or more geometric characteristics.

Optionally, the one or more constraints comprise any one or more constraint values relating to each of the one or more component designs; optionally comprising data; regulations; objective functions; geometry; special relationships; manufacturing constraints; design constraints; rules of thumb; and/or values.

Optionally, the method includes a step of determining one or more representations based on the plurality of properties for the one or more component designs; optionally wherein the one or more representations comprise any or any combination of semantic and/or geometric representations; cost; cost models; CAD models; G-Code; multi-physics; injection moulding; CFD/FE models/data; PLM data; supply chain and/or operational pathlines; factory design and/or flow; vehicle pathlines; assembly instructions; process flow diagrams; and/or assembly line processes. Optionally, the step of generating the output architecture further comprising a step of determining one or more representations based on the plurality of properties for the one or more component designs.

In some embodiments, representations can be generated/determined from one or a plurality of properties.

Optionally, the method includes a step of determining one or more adaptations and/or the one or more adjustments of the one or more representations based on any one or more of: change in relation to the one or more semantic properties and/or the one or more geometric properties.

In some embodiments, adaptions and/or adjustments can be made to the output designs or potential output designs automatically based on changes made to any of the inputs including the semantic or geometric properties.

Optionally, solutions and/or architecture are determined by converging possible values and variables within the interrelated primitives and/or architectures using learned algorithms.

According to a further aspect, there is provided a method for producing a model of a component design, comprising the steps of: receiving a plurality of inputs relating to the component design; and determining at least one semantic property and at least one geometric property of the component design.

Optionally, the plurality of inputs comprises at least one model of a component design.

In some embodiments, a model of a component design can be used as an input.

Optionally, the model defines one or more ports which provide an interface with other primitives and/or architectures. Typically, the ports that are shown or able to be used by a user will be constrained to enable the user interface to be easy to use. However, any variable within the architecture are able to be a port.

According to a further aspect, there is provided a method for determining an architecture comprising a plurality of properties for one or more component designs, the method comprising the steps of: receiving one or more inputs relating to each of the one or more component designs; determining characteristics of the plurality of properties for the one or more component designs based on the one or more inputs; determining one or more constraints for each of the plurality of properties based on the determined characteristics; determining one or more relationships between the characteristics of the plurality of properties and the determined one or more constraints; and generating an output architecture.

According to a further aspect, there is provided a computer program product for providing the method of the above aspects.

### BRIEF DESCRIPTION OF DRAWINGS

Embodiments will now be described, by way of example only and with reference to the accompanying drawings having like-reference numerals, in which:

FIG. 1 shows an illustration of a stack representation of an embodiment;

FIG. 2 shows an illustration of the interpretation model of an embodiment;

FIG. 3 shows an illustration of a simple component graphical representation according to an embodiment;

FIG. 4 shows an illustration of a simple semantics representation according to an embodiment;

FIG. 5 shows an assembly structure representation of an embodiment of an example hierarchical tree for an architecture of architectures and primitives, or assemblies/sub-assemblies and parts;

FIG. 6 shows an example graph based geometry generation of an embodiment for a gearbox architecture showing the interfaces between parts/primitives of an architecture;

FIG. 7 shows an example semantic and geometric information flow of an embodiment of an architectural system of the example in FIG. 6;

FIG. 8 shows an example of a composable architectural system of an embodiment using the example of FIGS. 6 and 7;

FIG. 9 shows a re-usable architecture example of an embodiment where a component is reused between architectures/designs;

FIG. 10a shows a pre-adapted example of an embodiment of an adaptive architectural system where the alteration of a primitive/part causes the rest of the architecture to adapt between the example of FIG. 10a and the example of FIG. 10b;

FIG. 10b shows a post-adapted example of an adaptive architectural system of an embodiment where the alteration of a primitive/part causes the rest of the architecture to adapt between the example of FIG. 10a and the example of FIG. 10b;

FIG. 11 shows a simplified example launch vehicle of an embodiment;

FIG. 12 shows some of the design and engineering considerations to be taken into account of an embodiment when designing a launch vehicle like that shown in FIG. 11, showing how variable inputs are flowed through a scalable architecture to produce one or more outputs;

FIG. 13 shows some of the design and engineering considerations to be taken into account of an embodiment when designing a launch vehicle like that shown in FIG. 11, showing how the different stages of the rocket are configured and how these relate to each other via an interstage structure;

FIG. 14 shows some of the design and engineering considerations to be taken into account of an embodiment when designing a launch vehicle like that shown in FIG. 11, showing how the flow of propellent can be modelled through the system;

FIG. 15a shows the progress of designing an example hand tool according to an embodiment, starting with the outline requirements for the components of the tool;

FIG. 15b shows the progress of designing an example hand tool according to an embodiment, showing a visualisation of the components in the outline requirement;

FIG. 16a shows the progress of designing an example hand tool according to an embodiment showing how the components in the outline requirements are initially connected;

FIG. 16b shows the progress of designing an example hand tool according to an embodiment, showing a visualisation of the components in the outline requirements as initially connected;

FIG. 17a shows the progress of designing an example hand tool according to an embodiment, showing the addition of two additional components to the design;

FIG. 17b shows the progress of designing an example hand tool according to an embodiment, showing the visualisation of the existing tool design and the additional components to be added to the design;

FIG. 18a shows the progress of designing an example hand tool according to an embodiment, where all of the components have now been connected as required for a final design;

FIG. 18b shows the progress of designing an example hand tool according to an embodiment, showing a visualisation of the final design; and

FIG. 19 shows a flow diagram of a generalised overview of the steps involved in determining the representation of a component design of an embodiment.

### SPECIFIC DESCRIPTION

Parts are traditionally seen as geometric objects, however in embodiments they can be represented as parametric descriptions of objects, or (engineering) functions, that may lead to a variety of solutions depending on the values of one or more variables—i.e. one parametric description/function can, depending on its parameters, describe zero, one or multiple disjoint geometric objects. The word ‘part’ in this specification is intended to refer not to a single contiguous geometric object but rather to a semantic and/or geometric unit.

In embodiments, parts may be related to each other by means of ‘interfaces’. Each interface on a part may be expressed as a “port”, which may be given a human-readable name for ease of reference. Interfaces or ports can connect to another between parts, combinations of parts, architectures and/or systems. One interface may fit with another interface precisely or imprecisely, completely or partially, typically depending on the requirements or specification or other input.

A network of parts, along with their ports and interfaces, may together form an ‘architecture’—this represents the ability to present portions of parts or parts or even complex products as abstract single entities, e.g. a gear tooth; a gear; or a rocket. In embodiments, for scalability, abstraction by aggregation may be used. Through abstraction by aggregation, whole architectures can be aggregated into part-like entities and be, in turn, used in other architectures which may be similar or heavily different architectures. Alternatively, abstraction can be via some other means, for example by semantic abstraction or to allow variables to have a value to be assigned at a later date.

Other definitions of terms used in at least some embodiments are as follows:

A “name” is a word or piece of text, i.e. a string, used to refer uniquely to an entry in for example a name-based table.

A “qualified name” is a sequence of names describing a sequence of references in nested structures.

A “name lookup” is a polymorphic operation that takes as one input a (data) structure containing for example name-based tables and as another input a name or qualified name for which relevant data is output.

A “value” is representative of an object in any of the underlying domain languages.

A “configuration” is a mapping from names to values.

A “defining type” is an annotation on a part or interface (but does not overlap with names or qualified names).

A “part” describes a non-decomposable element in a design, and consists of a defining type, a configuration and a set of names from either geometry or configuration that are exposed as parts.

A “part type” is, for a part, defined as the pair of its defining type and the set of names in its configuration.

An “interface” is a relation between two parts. Where possible these relationships are undirected (or symmetric) but interfaces can be directed or undirected. Like parts, interfaces have a defining type and a configuration. Assuming the representation of pairs encodes explicitly whether they are ordered or not, interfaces can be expressed in terms of the disjoint union of ordered and unordered pairs. The meaning of an interface is defined, in part, by which types of parts relate to each other. This is reflected in the definition of interface types.

An “interface type” of an interface is threefold, including a defining type, the defining types of the connected parts; and the set of names of the interface's configuration.

A “component” is either a part or an architecture. Parts and their connected interfaces, together, describe architectures. To allow hierarchical composition, architectures can take the role of parts in other architectures.

An “architecture” consists of components and interfaces between these components and the set of the architecture's externally visible names, with their mapping to internal qualified names.

In embodiments, the definition of parts and sub-architectures may be interchangeably termed ‘component designs’. In this sense, aggregated architectures may also be “part-like” in that they comprise parts within their structure or structural design.

Example embodiments seek to provide a semantics based programming model which considers and develops upon different types of programming models in order to build a formalization of the engineering design process. The different types of programming models include any or any combination of imperative, declarative, relational and/or flow-based programming models, although in some embodiments other programming models can also be developed to enhance or modify this semantics based programming model. Programming models or paradigms and their features may be understood as would be by the skilled person in the art within the field of computer programming,

The language used with embodiments has three core concepts: building blocks; means of combination; and means of abstraction. Building blocks, sometimes called primitives, are linked together with the means of combination. Then, to move the language to a higher-level of abstraction, these building blocks and the means of combination used to connect them, can be grouped by means of abstraction. Two approaches are presented in the following described embodiments: a relational model and a flow-based programming model.

The relational model uses building blocks that are specific engineering elements or “primitives” such as a gear or a shaft; then the means of combination(s) are represented by interfaces in the primitives that can be linked together. Combinations of primitives and their means of combinations can then be grouped to create larger or more complex components (e.g. primitives) from each of the grouped primitives and means of combination.

The relational model generates a complex dependency graph and a solver is used to determine, generate or re-use values into the graph and then generates a (design) instance.

In an embodiment using the relational model, the process can be performed using a sequence of translation steps: the first step is to generate a dependency graph (i.e. a plurality of interconnected equations); the second step is to resolve the graph to generate a design instance (i.e. numbers are provided as input values for the interconnected equations and the remaining unknown values are then solved and/or operations performed); and the third step is to generate the instance/output the instance (i.e. once all or the possible values are solved).

The flow-based programming model uses building blocks which are a series of statements/events/activities that can be performed by the computer and which can be individually configured or allowed to react depending on their inputs/outputs/properties. The building blocks receive input data from one or more ports, will do something with that data, and expose the results as output ports. The building blocks can be connected together with a “wire”, i.e. a (logical) connector that can be represented visually in the user interface, which indicates that two building blocks are linked (and can by used to specify how blocks are linked if this isn't automatically determined). Wires transmit data from one block to another, and connect at ports of blocks. Similarly, building blocks and wires can be combined into groups that can be represented by a larger/more complex building block or assembled building block to enable higher-level designs to be made as users can hide complexity as necessary.

Designs can be created in a “workflow”, the workflow being where all of the semantics, geometry and calculations are specified. The workflow enables the computational architecture to, for example, display a visualisation of the design process (the workflow itself), as well as the output design as the workflow is created, updated or tested by a user. Changes to a design are propagated as required through the building blocks and wires, either by changes to static data or changes to dynamic data.

The design space can be explored by using, instead of single values for a design point, using a range of values for one or more static or dynamic data/values.

Using the flow-based programming approach, in an embodiment, first the process is written in a workflow and second the computer executes the workflow. This allows users to re-use portions of workflows that are common, either to duplicate design protions or to create more complex designs or re-use design portions for other aspects of a design.

In either or both of the relational model or the flow-based programming model, any or any combination of name; qualified name; name lookup; value; configuration; defining type; part; part type; interface; interface type; component; and/or architecture can be used.

With reference to the accompanying Figures, several example embodiments will now be described.

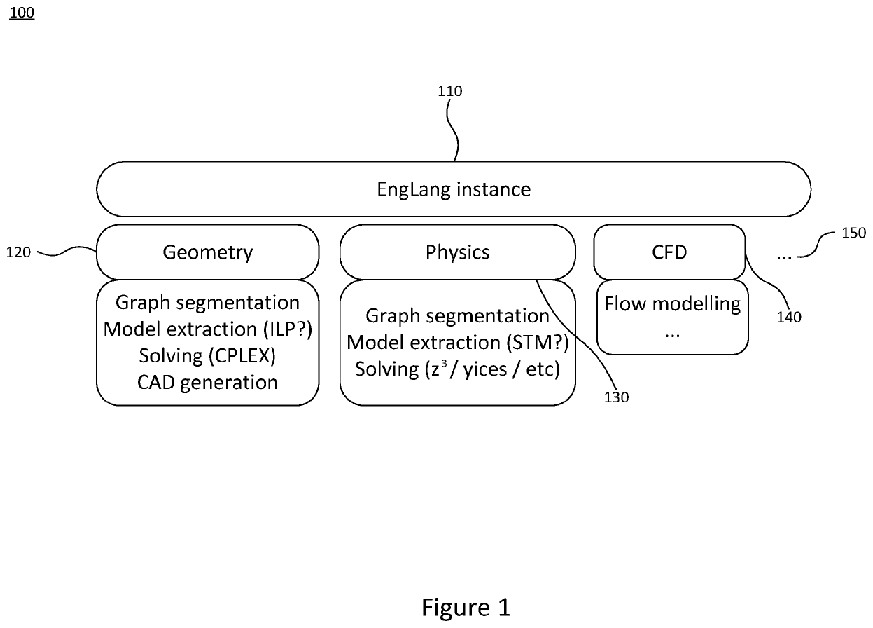

FIG. 1 shows an example representation 100, shown as a stacked rendering, of the interpretation model used according to at least one embodiment.

In FIG. 1, the language used is termed “EngLang” which refers to the ‘relational model’ and the models 110 created using this language need to describe different knowledge domains (for example, as shown, geometry 120, physics 130 and computational fluid dynamics 140 are all domains that can be used for interpretation and that can be described using the language). Other knowledge domains 150 may be used in addition or in place of any or all of the example knowledge domains 120, 130, 140. Some models 110 may only need a limited number of knowledge domains 120, 130, 140, 150, but other models 110 may require a large number of knowledge domains 120, 130, 140, 150 in order to describe and interpret any model 110 in the language. By using a common language to describe, model and interpret a collection of knowledge domains 120, 130, 140, 150 the models 110 expressed in the common language can describe and inter-relate the one or more knowledge domains 120, 130, 140, 150 in an integrated fashion. Alternatively, “EngLang” can use the flow-based programming approach in other embodiments.

Interpreting an “EngLang” model 110 involves knowledge from the different knowledge domains 120, 130, 140, 150. The purpose of the language is to describe architectures (which can be thought of as “schema of designs”) and to generate (or generate documents for) single designs from the architectures once some or all values have been provided for each design. Which knowledge domains 120, 130, 140, 150 are required to generate a design from an architecture can vary depending on the sub-field of engineering an architecture originates, so the language of the embodiments can be extended by adding new parts, interfaces and/or knowledge domains 150.

By providing a common language to allow relationships/integration between knowledge domains using the “EngLang” language and model 110, calculations can be performed within each domain based on the model and also allows compound calculations to be performed drawing from multiple domains—so for example torque may be determined by the Physics domain 130 and then the value for torque can be used by the Geometry 120 domain to determine some aspect of a piece of geometry for that model.

The knowledge domains are represented in FIG. 1 as being independent, but this is just an example to illustrate the relationship and expandability of the knowledge domains 120, 130, 140, 150, in particular the relationship to the “EngLang” language and model 110. The Figure doesn't show the information flows from one domain to another via the model/instance 110.

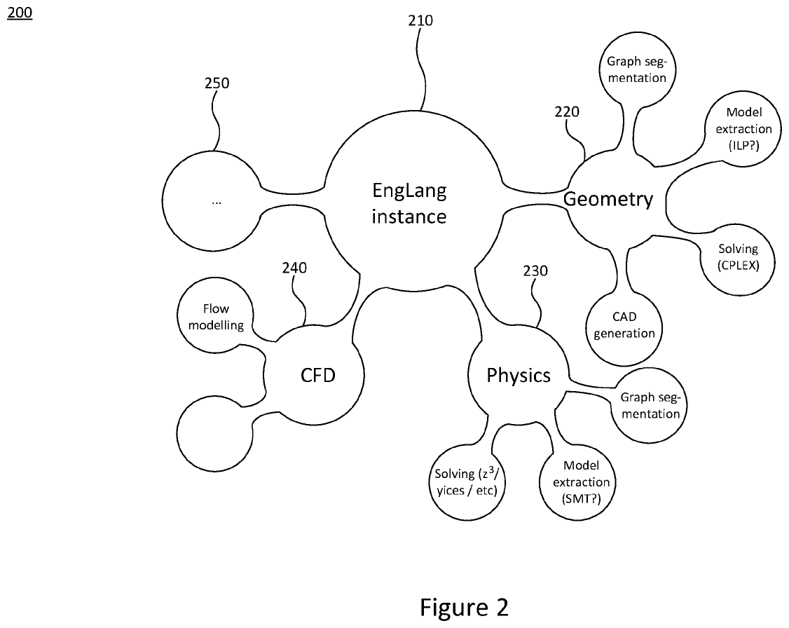

FIG. 2 shows the interpretation model of FIG. 1 in a graph representation.

In FIG. 2, by representation in a graph arrangement, the interpretation model 210 is shown in a way that illustrates how each knowledge domain 220, 230, 240, 250 can be structured with sub-domains (and each sub-domain can itself have further layers of sub-domains). The model/instance 210 in at least one embodiment performs segmentation to auto-generate relationships between the variables that can be used in the EngLang language and which domain/sub-domain can solve each variable (and what variables are dependent on other variables being solved first)—typically stored as a dependency graph. This allows the derivation of which sub-graph/knowledge domain/sub-domain should be used to translate to which models and in which order. Each solution to each variable is able to be written to the model by each sub-graphs/knowledge domain/sub-domain.

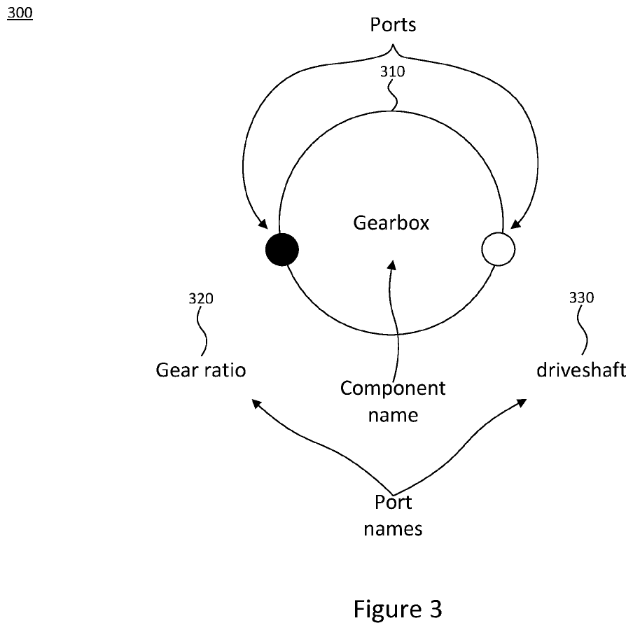

FIG. 3 shows a graphical notation 300 of a single component design 310. This component design 310 in this example representation is labelled ‘Gearbox’ comprising two ports i.e. ‘gear ratio’ 320 and ‘driveshaft’ 330. In this example, “gear ratio” 320 refers to a ‘variable’ which may be used to define part of the functionality of this component design 310, and “driveshaft” 330 can be described as a specific part of the underlying geometry of the component design 310 which other geometries can then be interfaced with (the terminology may be slightly unclear in this example, as while a driveshaft may interface with the gearbox 310 at the driveshaft port 330, other parts may interface with the driveshaft port 330). Although in FIG. 3 the two-component design 310 and its ports 320, 330 have been defined, this is an example which may be adapted according to the component design 310 in question and/or defined flexibly within the system 300.

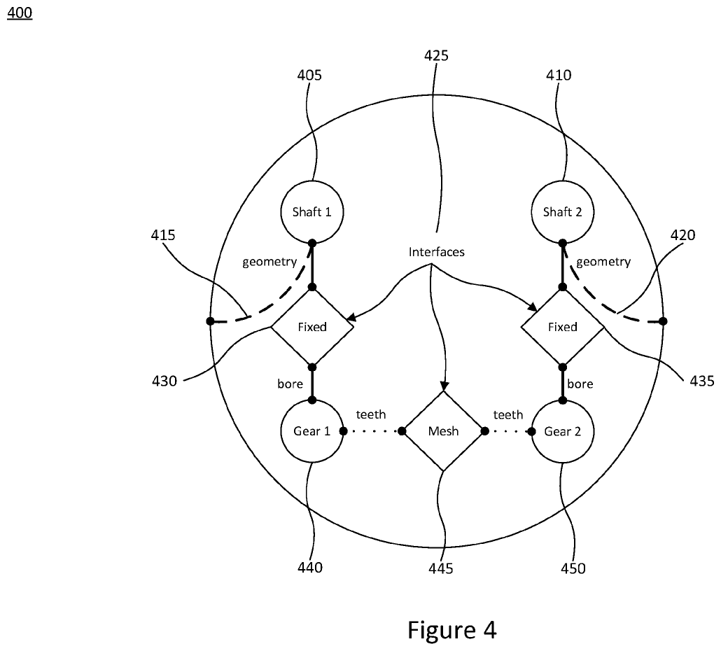

In FIG. 4, an architecture 400 is shown having several component designs, 405, 410, 430, 435, 440, 445, 450 connected with interfaces 425.

The dashed lines indicate the ports 415, 420 that enable interfacing with this architecture 400.

In embodiments, the language used for the implementation of models allows for non-specific variables or even non-specific portions of a design as such embodiments extend current computer aided designs with semantics and semantical definitions which apply to those semantics. For example, the need for a propulsion means may be specified but no further details of the type of propulsion means is provided, and either the type of propulsion means can later be specified manually by a user in order to produce a final design or the model can solve for one or more types of propulsion means that meets the input requirements/specification provided by a user, thus determining and including details for the unspecified propulsion means in the final design that is produced. Thus, the solution or values for one or more parameters may come from a number of semantic or geometric domains (or knowledge domains), for example, underlying physics of the component design or cost models.

Semantic domains may have their own value descriptions with or without their own type systems. The gear ratio, mentioned in our first example, for instance, is a unitless numeric value. Many designs are based on equations which do have consistent units which remain consistent (torque, stress, electrical resistance, supplier component cost, etc.). Some embodiments however may not define or restrict these domains, nor impose value or type representations, instead embedding them as domain specific languages or in other embodiments as a single major language. Other embodiments do not embed these as domain specific languages or as a single major language.

According to an embodiment using the relational model approach, the fixed interfaces 430, 435 require that, in the graph, a torque equality condition to the two object/items to which it connects for each interface. Thus shaft 1 405 requires a torque equality condition between the shaft and the fixed interface 430 in the graph; and gear 1 440 requires a torque equality condition between the gear and the fixed interface 430. Each of the components, e.g. the shaft 1 405, would also be modelled in the relational model with their own properties/values/equations and each other interface and port will also be modelled. Thus, for example, the mesh interface 445 would include the condition:

$$\frac{{T}_{1}}{{T}_{2}} = \frac{{r}_{1}}{{r}_{2}}$$

where T is torque and r is radius. Once the compete set of interconnected equations and relationships have been determined for all of the components of a design and this has populated the graph, it would be known for the above examples that:

T₁=T_{gear 1}=Tₘₒₜₒᵣ

T₂=T_{gear 2}=T_{wheel}

r₁=r_{gear 1}

r₂=r_{gear 2}

where these relationships between torques and radii can be used to solve for a given set of inputs, by first generating a dependency graph capturing all of these.

Using the populated dependency graph, the set of equations are resolved and/or solved to produce a specific output in the form of a design instance. For example, the user inputs a set of values for the design instance and, given a minimum defining set of variables to be able to solve the equation(s), a set of solved equations are produced and output values such as radius and torque values are output as part of the design instance.

Following the set of solved equations and output values being produced, the design instance is generated, so for example shaft 1 405 the variables r (radius) and l (length) are retrieved from the solved/resolved graph and a circle with radius r is drawn then the circle is extruded by length l. The computer system now has all of the information it needs to execute the programming and can, for example, generated a 3D design instance for the user to review and/or use as required.

Alternatively, in another embodiment using the flow-based programming approach to create the design instance for the example shaft 1 405, the process would be written as (1) input radius r; (2) draw circle; (3) extrude by length l. This can achieves the same output design instance as using the relational model approach but can allow the computer to perform more of the execution work.

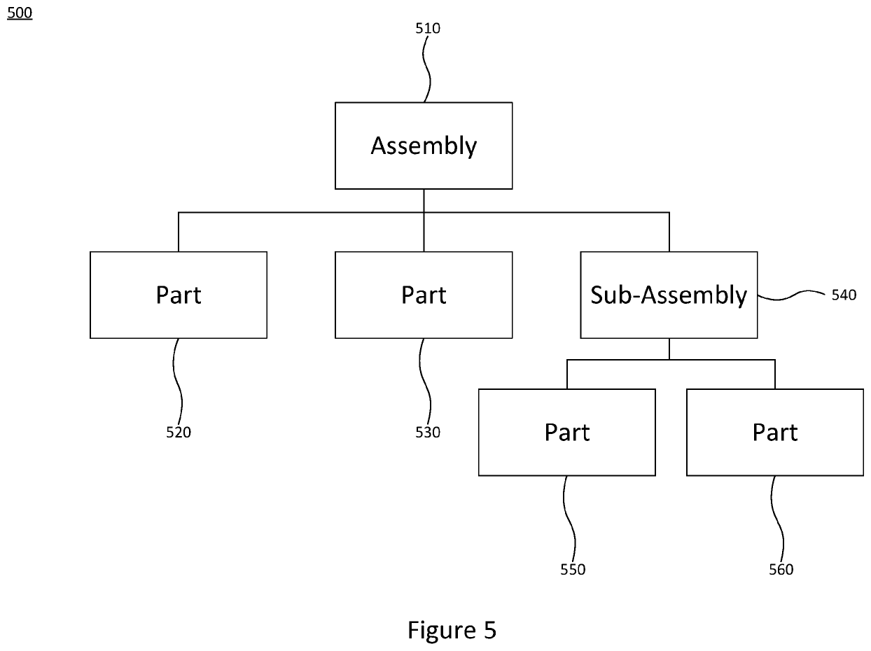

FIG. 5 shows an assembly structure representation 500 of a hierarchical tree comprising an assembly or architecture, parts, and sub-assembly or sub-architectures. Specifically, in the example shown, an assembly 510 is made up of two parts 520, 530 and a sub-assembly 540, the sub-assembly 540 made up of two parts 550, 560. In three dimensional representations or a product structure, it is sometimes possible to interpret geometric constraints and the engineering intent may be assumed or implied. However, it is not the case in current art to be able to recognise or establish the semantic relationships between parts, architectures, sub-architectures or component designs as a whole.

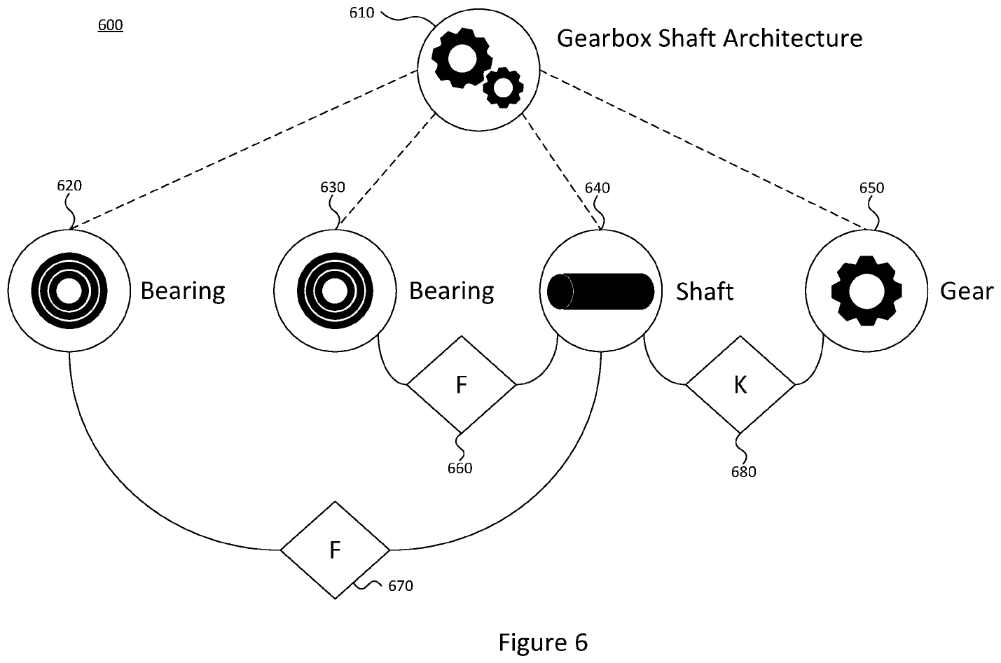

FIG. 6 illustrates a graph based geometry generation 600 comprising a gearbox shaft architecture 610, bearings 620, 630, a shaft 640 and a gear 650. The inclusion of the semantic relationships in between these parts is also shown. Each bearing 620, 630 has a respective “fit” interface 660, 670 with the shaft 640 and the shaft 640 has a keyed interface 680 with the gear 650. This means that the bearings 620, 630 must interface to fit with the shaft 640, while the shaft 640 has a keyed interface to connect to the gear 650.

In an exemplary declarative model, for example as shown in FIG. 6, a gearbox shaft architecture 610 can initially be input as the desired architecture or as a combination of parts or sub-architectures. Once a desired architecture or sub-architecture is input, a set of relevant libraries are loaded and the model can then generate a graph containing all data dependencies and relevant variables to form a functional architecture. In order to create the desired architecture, the appropriate constraints are placed through additional input. Constraints are not limited to but may include, for example, the size or weight of the desired architecture, interfaces between certain parts (such as mesh or fit . . . ), particular primitives to be used (such as a gear, plastic injection, or moulded component . . . ), equations of primitives, or the size or weight of parts etc. With reference to FIG. 6, the size of the gearbox shaft architecture 610, a gear equation for gear 650, a key equation for the keyed interface 680, or the particular “fit” interface 660 connecting bearing 620 to the shaft 640 may be set as potential constraints. Through a series of inputs, the programming model can generate a single architecture/design point to be presented as the desired architecture to the end user, which can in turn instantiate a CAD file, for example.

In many cases, it may be favourable for those involved in the engineering design process to be able to develop or input a series of events (events, for the avoidance of doubt, can be for example lines of code, engineering processes, or functions that perform a task/action/calculation, like for example to look up a coefficient from a database, extrude a circle by radius, or check that a value is within a correct range of values) that can be used to generate a desired architecture or a combination of such. Thus, in another example, as an alternative to “declaring” the desired result, a series of events for a particular design of interest can be set.

By way of designing the program, this ‘imperative’ programming model can generate an architecture/design point to be presented as the desired architecture to the end user. Through this workflow, a range of variables in each degree of freedom can be used to map the design space. Thus, an important characteristic of this model in comparison to the declarative model workflow above is the order of events.

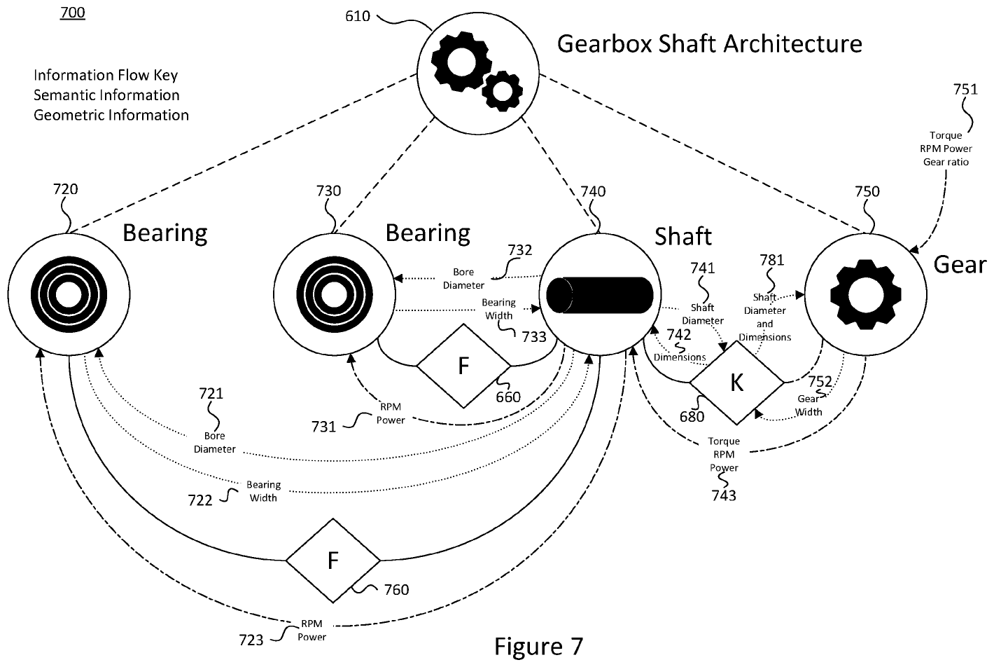

FIG. 7 illustrates most if not all engineering reasoning, intent, and information explicitly in one area in relation to the example shown in FIG. 6. Through this visualisation, architectures of systems can be created and modified, engineering considerations such as torque, stress etc. as well as inter-part relations can be recognised and determined, and complete or substantially complete three-dimensional component designs can be generated, all directly from the architecture. In this example, for the geometry shown: the bore diameter 721 and the bearing width 722 and the RPM Power 723 of the first bearing 720 interfacing with the shaft 740 is captured in the model 700; the RPM Power 731, the bore diameter 732 and the bearing width 733 between the second bearing 730 and the shaft 740 is captured in the model 700; the shaft diameter 741, keyway dimensions 742, torque RPM power 743 for the shaft and the shaft diameter keyway dimensions 781 for the shaft 740 and the gear 750 are captured in the model 700; and the torque RPM power gear ratio 751 and the gear width 752 for the gear 750 are captured in the model 700.

In the example embodiment of a model 800 of a gearbox 810, as shown in FIG. 8, which illustrates an architectural structure of an input shaft 820, output shaft 830, and an idler shaft 840 which all combine to construct a component design gearbox 810, it is possible to stack architectures and/or component designs in order to build simple or complex systems, providing a potential solution to some or all of the problems of scalability and information/complexity management. Between the shafts 820, 830, 840 there are mesh interfaces 850, 860 to define how the shafts interconnect. Each of the shaft 820, 830, 840 architectures are essentially the architectures shown in the examples of FIG. 6 or 7 reused as component parts of a large architecture 800.

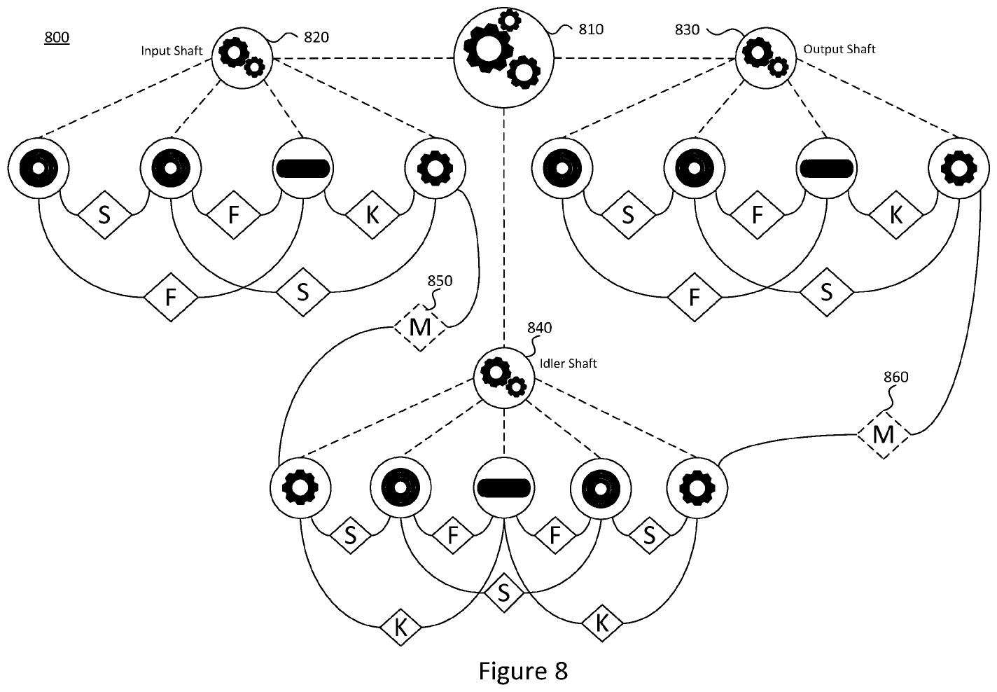

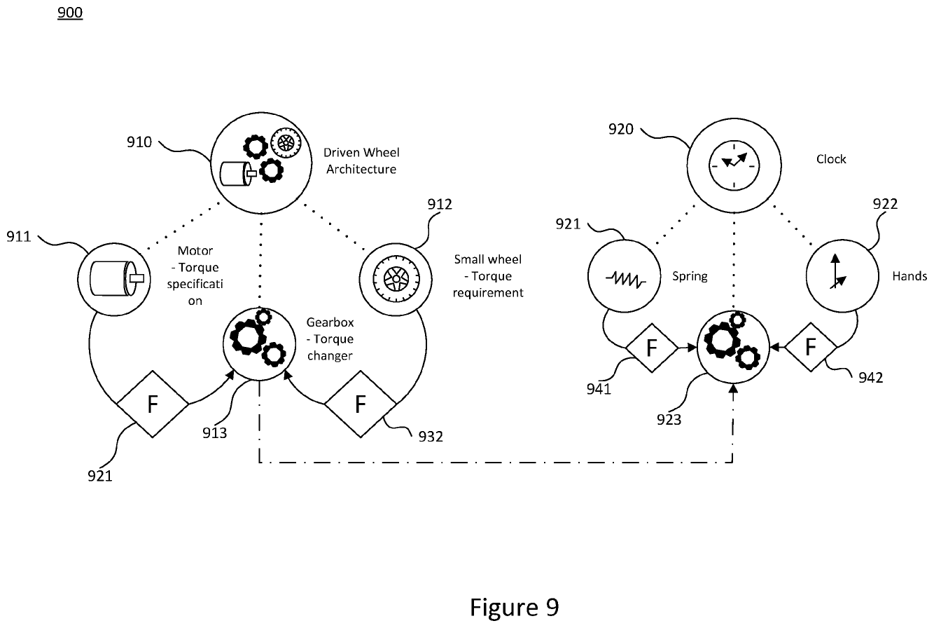

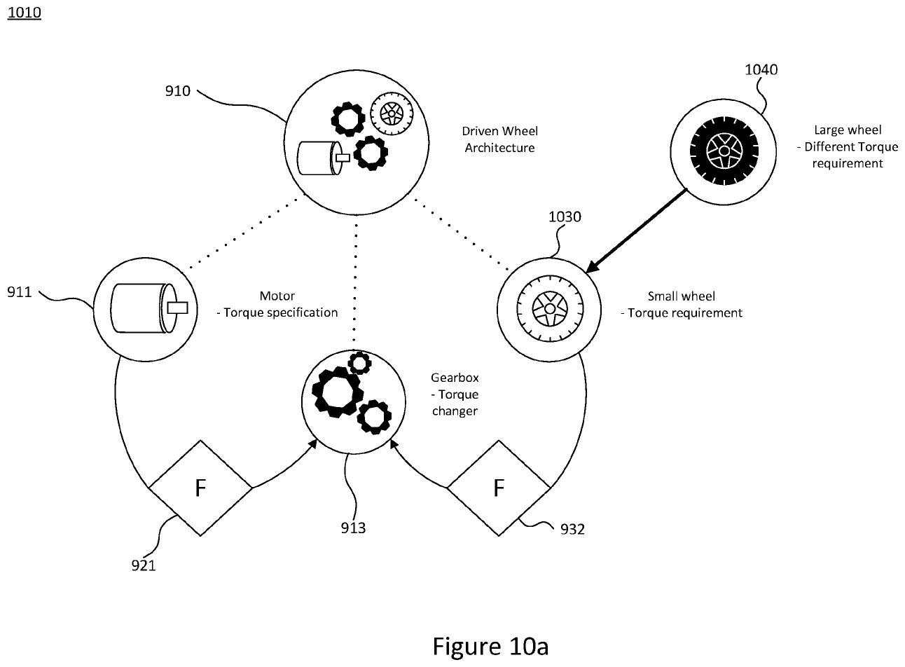

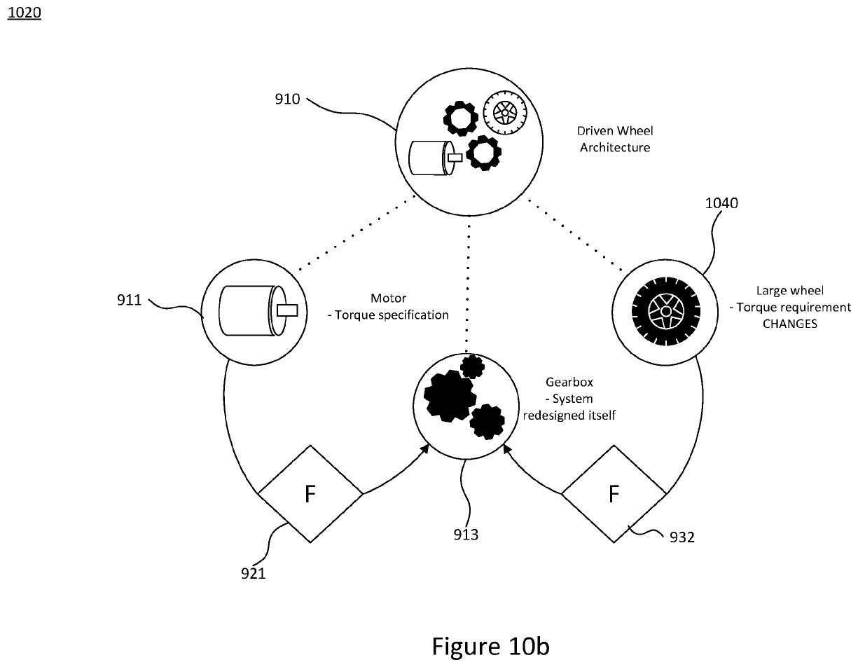

In embodiments, systems or component designs, architectures and parts can be re-used in similar or completely different contexts and provide an adapted system. For example, in the case of a gearbox, within current computer aided design processes, even if parametric models have been initially created, when starting a new project in which one wishes to re-use the gearbox defined the risk of re-using the previous design is that there is no semantic or engineering reasoning built into the existing design/model so there may be unintended consequences if the re-used design is used in a way that was not anticipated when the re-used design was originally created. However, in this example embodiment, as shown in FIGS. 9 and 10a/b, semantically driven architectures can automatically adapt to the requirements driven by new projects or new interfaces. For example, a gearbox 913 used in one component design 910 may be re-used 950 as a gearbox 923 in another completely different component design structure 920 and can interface with different requirements to which it will adapt. Examples of adaption can include: semantic changes such as new torque requirements; or an environment change such as the desired manufacturing method or literal environment (engineering requirements for example relating to the heat inside the part being designed, for example the heat tolerances being increased, thus there being a resulting likelihood of increased expansion of the gears in use or at some operating temperatures, or generating a gear with a different number of teeth).

In the example shown in FIG. 9, the first component design 910 is a driven wheel architecture having a motor 911 and a small wheel 912 connected to the gearbox 913 by fixed interfaces 931, 932 while the second component design 920 is a clock having a spring 921 and hands 922 again interfacing using fixed interfaces 941, 942 to the gearbox 923. Because the model of the gearbox is the same underlying architecture but can adapt based on the interface information and semantic information of each model 910, 920 it can be re-used in both models without unintended consequences.

In the example shown in FIGS. 10a and 10b, in the first architecture 1010 shown in FIG. 10a has many of the components 910, 911, 921, 913, 932 of FIG. 9 but instead of small wheel 912 a small wheel 1030 is present in the design. In this example, the user wants to replace this small wheel 1030 with a large wheel 1040, so this is done using the user interface and design/architecture 1020 is created as shown in FIG. 10b, the architecture 1020 using the large wheel 1040 instead of the small wheel 1030. In the first architecture 1010 the motor has a torque specification and the gearbox has a torque changer value while the small wheel 1030 has a torque requirement. By exchanging the small wheel 1030 for the large wheel 1040 which has a different torque requirement, the gearbox 913 properties change adaptively in the model as the torque requirement of the wheel changes.

Embodiments may provide various advantages. Firstly, a substantially optimal or correct system can in theory be produced, subject to the necessary/all of the design inputs, parameters and/or choices having been made and/or input (and subject to the design/completeness of the primitive components/architectures used), hence substantially no further optimisation is required in such substantially optimal systems thereby reducing both system and development costs and/or development time. Correctness or the degree to which a design is optimal may be judged according to various metrics, such as for example (a) the best design for a given cost or (b) the best design for a given one or more objective function; (c) substantially exactly the design needed given the inputs/constraints/requirements. Secondly, the architecture may (straightforwardly) generate substantially optimum designs for any engineering task with full control over the design parameters. Finally, embodiments may provide a modular system, that is, the architecture can (straightforwardly) be updated in order to produce increasingly complex and substantially accurate results.

In at least one embodiment, a computational approach may be taken to building or developing part/architecture models in order to incorporate objective functions such as cost or weight, however in this case the cost modelling aspect may not adapt correctly due to the engineering complexity of the part/architecture model. This is because the economic/cost modelling used to predict the costing of one or more components cannot always be fully reduced to engineering parameters. As a result, first principle models may not be able to determine the optimum configuration based solely on engineering parameters. In order to improve the cost modelling of the part/architecture model, a semi-empirical approach may be implemented where an empirical cost function is created for specific components and then integrated with the part/architecture models (i.e. models converged on a solution or a set of solutions for a given variable or variables) produced to enable the use of one or more part/architecture models to determine an optimum configuration of the component design using these part/architecture models.

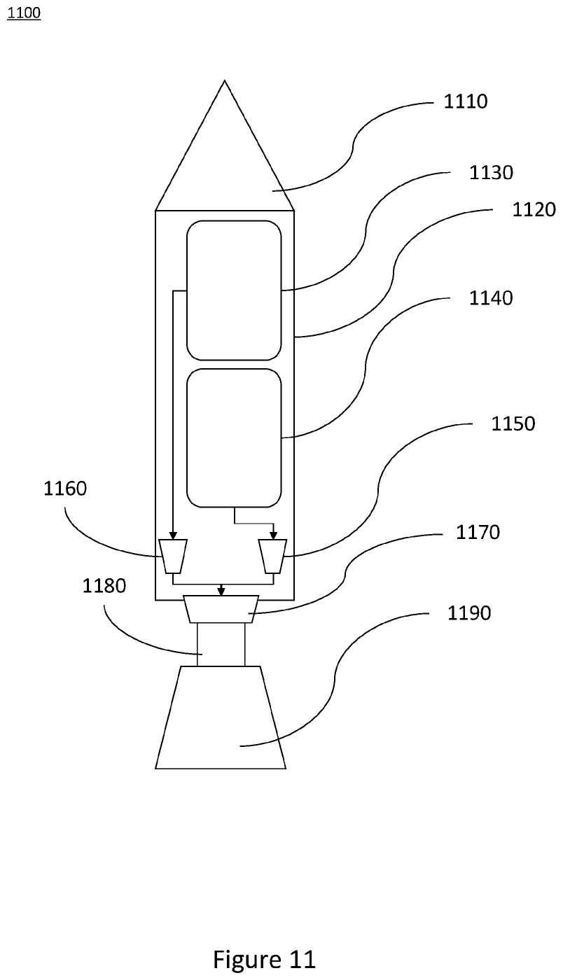

In another embodiment, the development of a model of a rocket 1100 will be described with reference to FIGS. 11 to 13.

Small rocket launch vehicles can have a high cost per unit of payload weight, as engines and auxiliary mass consist of a large proportion of the total mass. The economies of scale in rocket design and manufacture typically result in larger rockets having a lower economic cost per kg of payload as larger rockets carry increasingly larger payloads but the engines and auxiliary mass do not increase in proportion.

Referring to FIG. 11, an example simplified launch vehicle 1100 is illustrated. The launch vehicle 1100 has a nose cone 1110 and fuselage 1120. Within the fuselage 1120 is provided a fuel tank 1130 and an oxidiser 1140, the fuel tank 1130 connected to a fuel pump 1160 and the oxidiser 1140 connected to an oxygen pump 1150. The fuel pump 1160 and oxygen pump 1150 are in turn connected to a combustion chamber 1170. The combustion chamber 1170 is connected in turn to the throat 1180 and the throat 1180 to the nozzle 1190. The launch vehicle 1100 functions by providing the fuel pump 1160 and oxygen pump 1150 with fuel and oxygen respectively from the fuel tank 1130 and an oxidiser 1140 respectively. The fuel and oxygen are provided by the fuel pump 1160 and oxygen pump 1150 to the combustion chamber 1170 in the correct ratios by the fuel pump 1160 and oxygen pump 1150 in order to provide thrust through the throat 1180 and nozzle 1190 to cause the launch vehicle 1100 to ascend away from the ground.

As launch vehicles 1100 increase in size, however, more demanding engineering requirements (such as the combustion chamber 1170 being under increasing pressure and temperature) raise the engineering design complexity of a launch vehicle 1100 and hence typically drives up the costs of the system as there is an increased cost in respect of designing the vehicle 1100. Engineering complexity can initially be broadly defined as a measure of unique non-standard engineering components and manufacturing actions required to build the system/architecture or the component design. An example is the regenerative cooling channels required in the combustion chamber 1170, which are highly complex in large launch vehicles, as the heat released during combustion causes the gas to be heated above the melting point of the chamber walls.

Thus, the specific design of the combustion chamber 1170 in the example launch vehicle 1100 for a small rocket cannot be re-used or simply modified (for example by increasing the dimensions) in a larger rocket. Instead a new combustion chamber 1170 design is needed, or more typically a complete new rocket design is needed as all of the interdependencies of the designs of each part need to be taken into account in the design process.

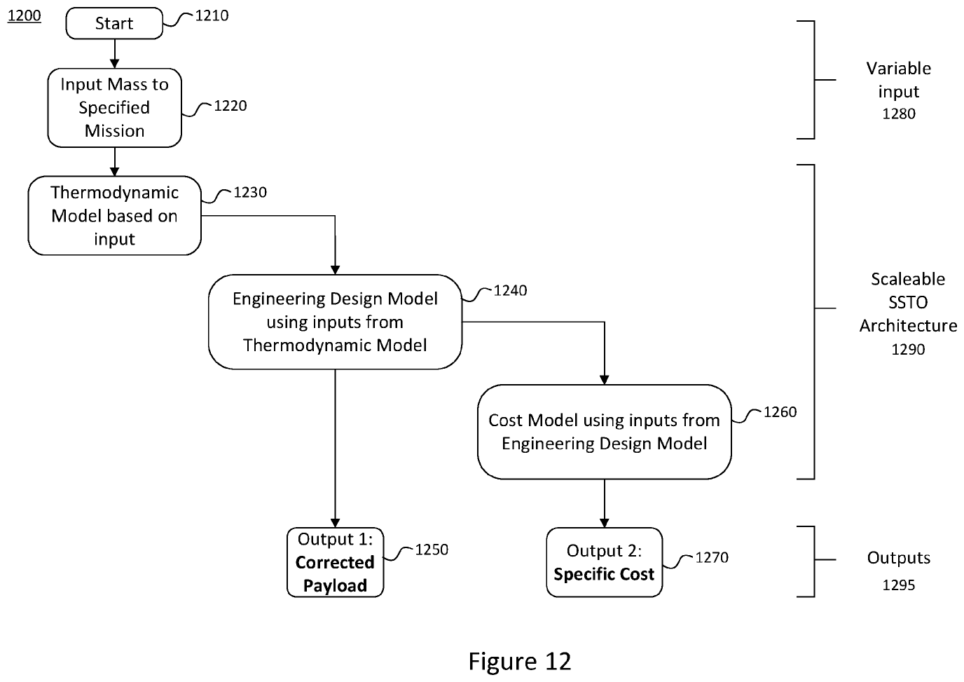

As for scalability of engineering components, current iterative design processes are computationally inefficient and multiple nested loops are required to derive a single design space solution. The primary problem with iterative design procedures is that the determined solution is a working design but isn't quite in line with the requirements in the initial specification. As a result, further optimisation studies are required throughout the designing and engineering process. In addition, the designer may have no understanding and a variable amount of experience, on whether the design provides an efficient solution. Examples of the interrelated design aspects for a launch vehicle can be seen in FIGS. 12 to 14.

Referring now to FIG. 12, which shows some of the design and engineering considerations to be taken into account when designing a launch vehicle like that shown in FIG. 11, further details of how variable inputs are flowed through a scalable architecture to produce one or more outputs will now be described.

FIG. 12 shows a flowchart 1200 detailing how the variable inputs 1280 flow through a scaleable SSTO (single stage to orbit) architecture 1290 to produce a set of outputs 1295. The flowchart 1200 starts 1210 with an input mass for the specified mission 1220 (e.g. to travel to the moon, or to a desired altitude or orbit) and a thermodynamic model 1230 is determined/generated/selected based on this input 1220. Following this, an engineering design model 1240 is determined/generated/selected using inputs from the thermodynamic model 1230. The first output 1295 is produced by the engineering design model 1240, specifically the corrected payload 1250 is output. The output from the engineering design model 1240 is also provided to a cost model 1260 and this provides the further output 1295, specifically the specific cost 1270.

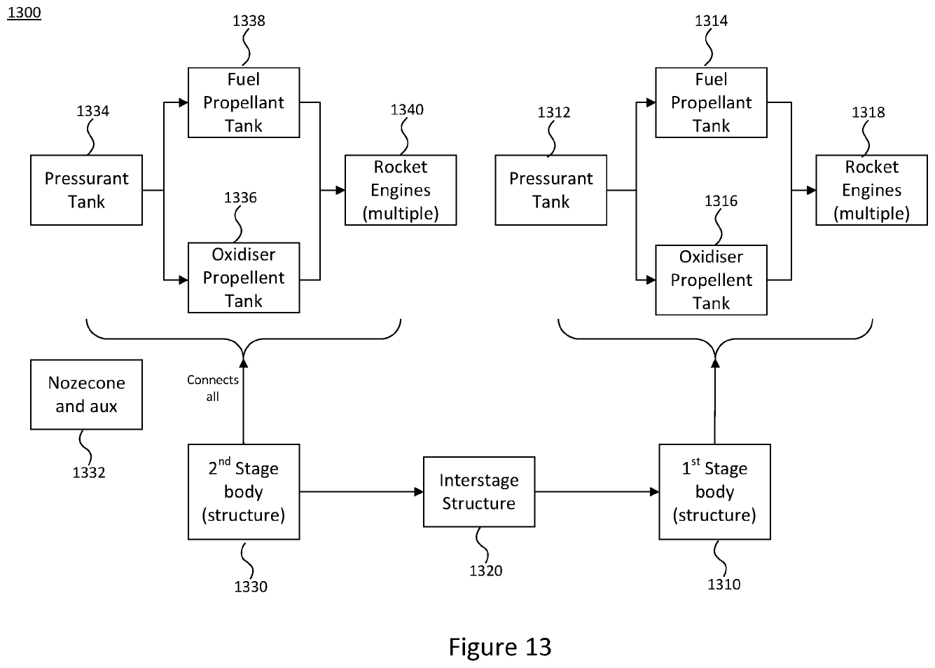

Referring now to FIG. 13, which shows some of the design and engineering considerations to be taken into account when designing a launch vehicle like that shown in FIG. 11, further details of how the different stages of the rocket are configured and how these relate to each other via an interstage structure will now be described.

In FIG. 13, an illustration of the components of the launch vehicle 1300 shows the first stage body 1310 and the second stage body 1330 linked by an interstage structure 1320, and that the second stage body 1330 is connected to a nose cone (and aux) 1332.

The first stage body/structure 1310 comprises a pressurant tank 1312 in communication with a fuel propellent tank 1314 and a oxidiser propellent tank 1316, both of which 1314, 1316 are in communication with a multiple rocket engines 1318. The second stage body/structure 1330 comprises a pressurant tank 1334 in communication with both a fuel propellant tank 1338 and an oxidiser propellent tank 1338 which are in turn both in communication with multiple rocket engines 1340. It should be noted that the first and second stage structures 1330, 1310 share a similar set of components.

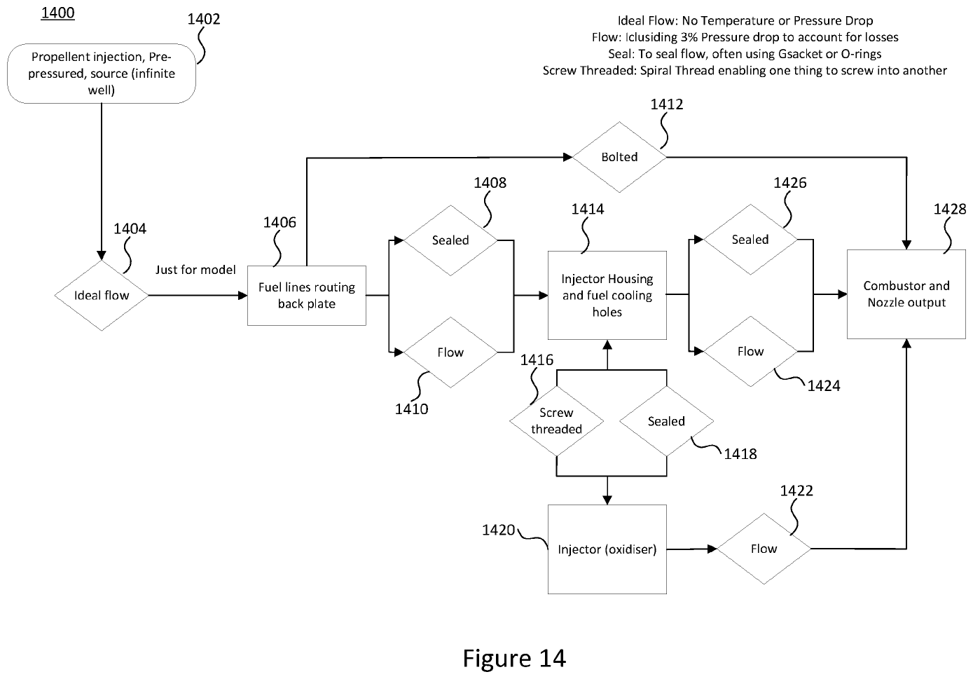

Referring now to FIG. 14, which shows some of the design and engineering considerations to be taken into account when designing a launch vehicle like that shown in FIG. 11, further details of how the flow of propellent can be modelled through the system will now be described.

FIG. 14 shows the flow of propellent through the propellent system of the vehicle 1400. The flow starts with propellent injection 1402 (e.g. including details of the pressure, whether it is pre-pressured, and the source which may for example be modelled as an infinite well) and an ideal flow 1404 is input, determined or generated (or kept as a variable/dynamic value to be determined by other aspects of the total system). From this the model represents the fuel lines routing back plate 140; connections such as the fuel lines 1406 being bolted 1412 to the combuster and nozzle output 1428 as well as being sealed 1408 such that there is flow 1416 to the injector housing and fuel cooling holes 1414. The injector housing and fuel cooling holes 1414 are in turn sealed 1426 and flow 1424 to the combuster and nozzle output 1428, as well as are screw threaded 1416 and sealed 1418 to the injector/oxidiser 1420. The injector/oxidiser 1420 is represented as flowing 1422 to the combuster and nozzle output 1428. By instead representing the design process for a launch vehicle using either the using the relational model or flow-based programming described above, re-use of components and portions of the design can be used to more rapidly design and investigate the design possibilities for the entire complex system.

The time required to create a design using current iterative approaches is large. Low technology readiness level (TRL) initial point designs can be created using the iterative processes within a week. However, to move up to a mid TRL detailed design, which includes designing parts, modelling, and testing, the process can take up to over five years. High TRL launchers must undergo several test flights in order to achieve flight qualification, the overall process of which can take up to ten years or more.

Embodiments provide a method for designing component designs in a scalable fashion without the need to produce iterations to reach a final working design or range of possible working designs. In the example embodiment of designing the launch vehicle, in order to achieve a scalable cost model, a macroscopic rocket and engine model must be designed. This ‘Engineering Design Model’ can scale the engineering components, such as pressure vessels, valves and combustion chamber, with payload size. In order to design each engineering component around its physical and thermodynamic requirements, a ‘Thermodynamic Design Model’ must be created as a starting point. The architecture therefore focuses on building a launch vehicle up from the fundamental design parameters instead of iteratively deriving these parameters from high level system requirements. The process therefore does not require iteration and builds a substantially optimal design solution for a range of variables including payload size. Thus, is it possible for a generic launcher model to be produced in the embodiments, as per the launcher in FIG. 11, but with modelled components that can be scaled and adjust as variables and inputs are changed in a way that can adapt to the increase in complexity as larger vehicles are designed.

It is clear that a scalable system cannot be created by using existing iterative design procedures. As a result, embodiments provide a solution for a substantially optimal design architecture. The potential benefits of the approach of the embodiments lie in its scalability, computational efficiency and ability to create a design without iteration, which are crucial to the success of modelling in all fields where engineering may be required. In addition, the design output may be the substantially optimal one for the given input parameters or a range of substantially optimal solutions.

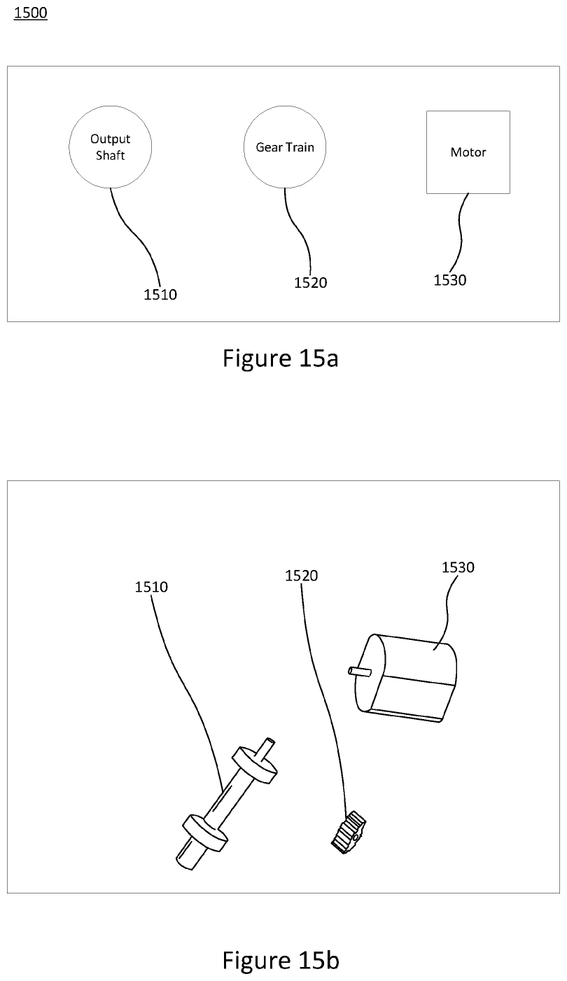

Referring now to FIGS. 15a to 18b, an example of a hand tool architecture model being constructed using a set of primitive design elements (or simply “primitives”) and/or architecture/part models will now be described. Such an approach, given well designed primitives, can be applied to the design of substantially anything.

At the beginning of the process of this embodiment, a user chooses three design elements or primitives for the planned design 1500. This is shown in FIGS. 15a and 15b, where a user chooses an output shaft 1510, a gear train 1520 and a motor 1530 to be primitives that will be used in the design 1500. In FIG. 15a this design 1500 is shown in a design user interface view and in FIG. 15b this design 1500 is shown in a CAD-style or 3D representation view.

As the primitives have only been selected for inclusion in the design at this stage in the design process, and there is no definition of how these parts interact with each other, the parts simply float in space with no interaction possible.

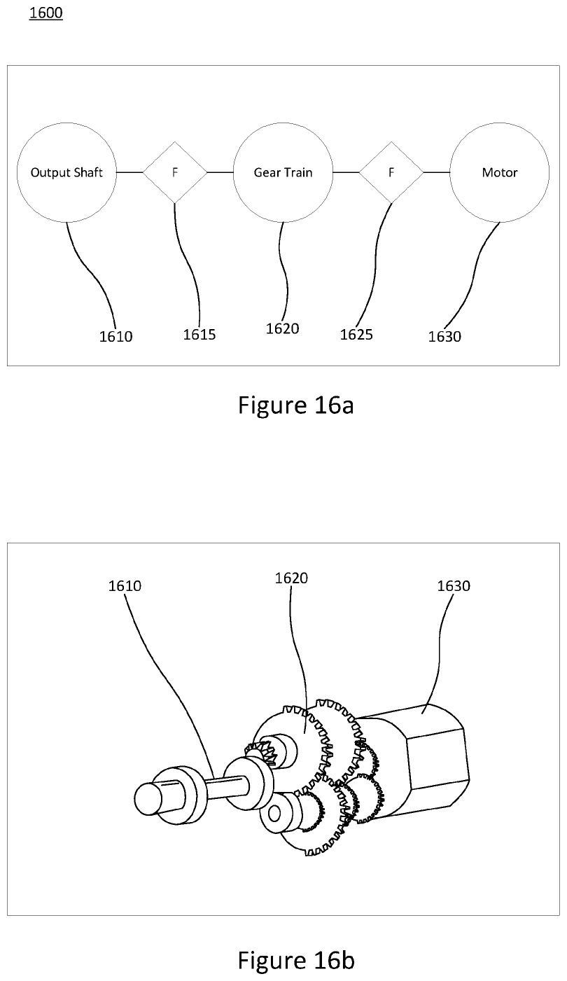

Referring next to FIGS. 16a and 16b, an example of the hand tool architecture model 1600 is shown now where two interfaces have been defined between the three primitives. A variety of interfaces are possible between primitives, but in this example fixed interfaces 1615, 1625 are defined between the output shaft 1610 and the gear train 1620, and between the gear train 1620 and the motor 1630. Now it shall be seen that in the design user interface view, the output shaft 1510, gear train 1520 and motor 1530 are connected together by lines specifying that the primitives interface with each other, and each line showing the interface also indicates the type of interface, in this case by “F” for each fixed interface 1615, 1625. Other ways to show this information are possible, this is simply one embodiment of the user interface to convey this information to a user. Correspondingly, in FIG. 16a, one can see that the 3D or CAD model of the hand tool design 1610 now shows a single object made up of the components interfaced together. To the extent that variables are input, or it is possible to converge on a solution, given the primitives and interfaces provided as modular building blocks the design shown in the 3D or CAD view will change. For example, if no dimensions are added or constraints put on size then a dimensionless design will be shown but if dimension or other variables are input then the design shown will be the converged design for that input, e.g. it may have certain relative or absolute dimensions or the type of primitive may change (e.g. based on anticipate torque or RPM etc).

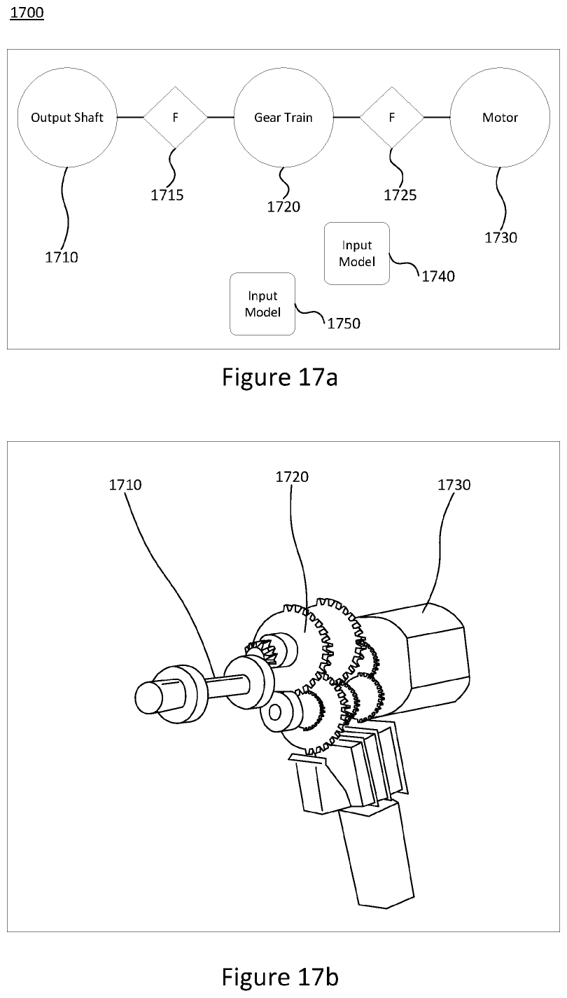

Referring next to FIG. 17a, further primitive elements are now added to the design 1700, specifically a battery 1750 and a printed circuit board (or PCB) 1740. As no interface between these new primitives has yet been defined by the user, they again float in 3D/CAD space in FIG. 17b. The existing primitives are defined as before, i.e. the output shaft 1710 is interfaced using a fixed interface 1715 to a gear train 1720, which in turn is interfaced using a fixed interface 1725 to a motor 1730. In this embodiment, the user is able to position the new primitives in the 3D/CAD view so that they are shown in the place the will appear when interfaced in subsequent steps, but this is purely for aesthetic reasons and can be done substantially automatically by the software if required.

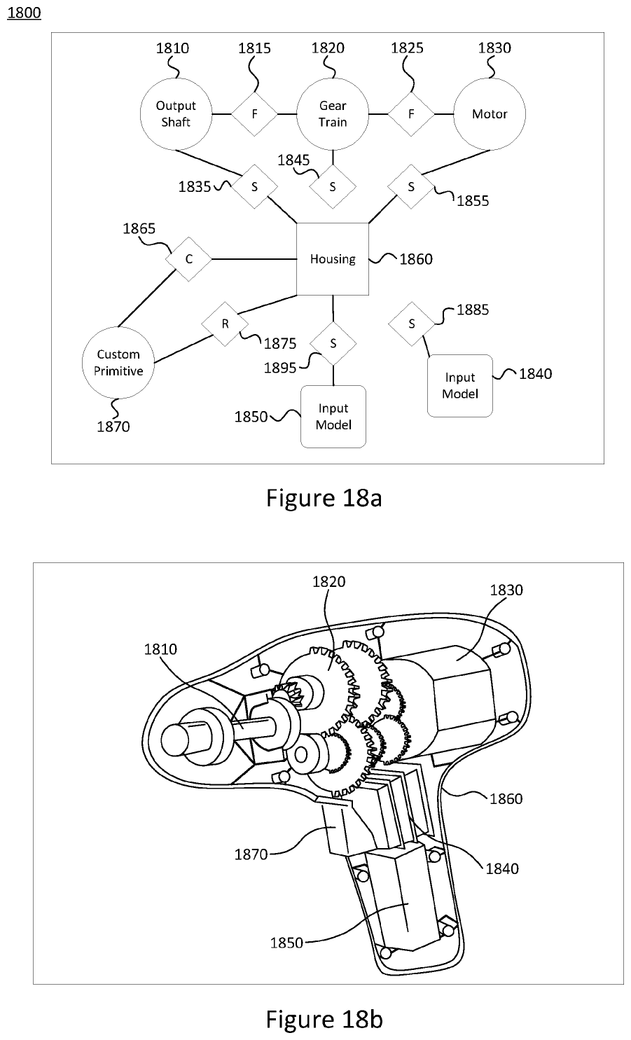

Finally, in FIGS. 18a and 18b, an almost final design 1800 is shown for the hand tool.

Here, the final primitives have been added including a housing 1860 and a trigger 1870 and the various interfaces defined between the primitives. Specifically, the output shaft 1810 is interfaced using a fixed interface 1815 to a gear train 1820, which in turn is interfaced using a fixed interface 1825 to a motor 1830 as before. Further, the output shaft 1810 is interfaced with the housing 1860 using a support interface 1835; the gear train 1820 is interfaced with the housing 1860 using a support interface 1845; and the motor 1830 is interfaced with the housing 1860 using a support interface 1855; and the new trigger 1870 is interfaced with the housing with two interfaces, a clearance interface 1865 and a rotational interface 1875; while the PCB 1840 is interfaced with the housing 1860 using a support interface 1885; and the battery 1850 is interfaced with the housing 1860 using a support interface 1895.

Further interfaces may need to be defined such as to connect the battery 1850 to the motor 1830 and the trigger 1870 to the PCB 1840 and in turn the PCB 1840 to the motor 1830 in order to make the hand tool design output a functional hand tool. Also, some inputs for certain variables may be required in order to produce design documents for manufacturing, including for example dimensions or weight constraints, or desired power output. This will enable design documents and/or CAD files to be output from the modelling process once the process has converged on a solution. Else a design requiring certain inputs can be stored or saved for the future when these inputs can be entered in order to produce design documents etc.

Given a different product to be designed, using a palette of existing architectures (i.e. existing designs made up of primitives) and primitives, a user can use this same approach to design a different product and input certain variables from the specification in order to constrain the design solution in order to output a set of design documents for manufacturing.

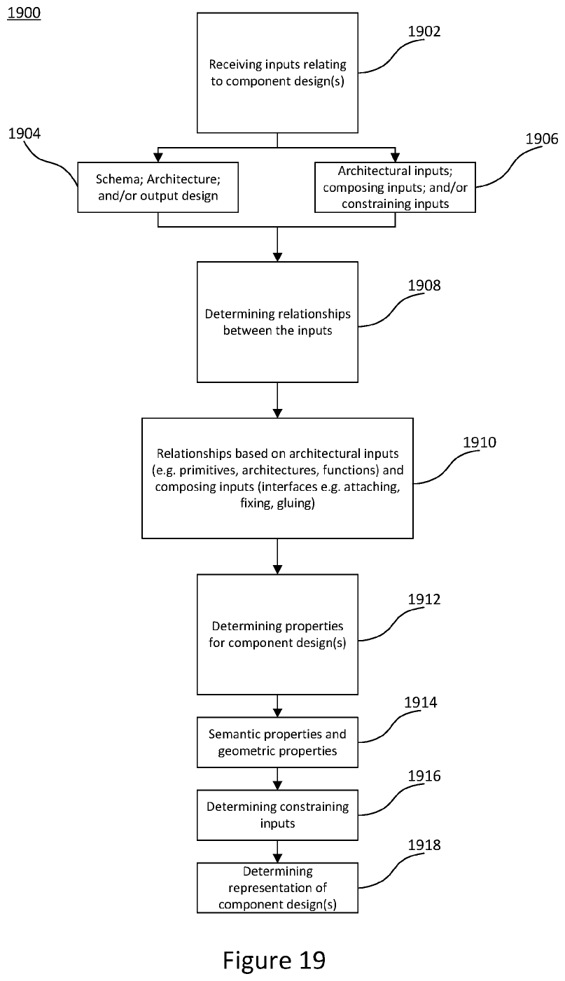

FIG. 19 shows a flow diagram of a generalised overview 1900 of the steps involved in determining the representation of a component design. Steps include: receiving inputs in relation to one or more component designs, as shown as step 1902, which may include schema, architecture, and/or output design, as shown as 1904, as well as architectural inputs, composing inputs, and/or constraining inputs, as shown as 1906. Next, in step 1908, relationships as determined between the inputs as appropriate. These relationships are based on architectural inputs, e.g. primitives, architectures, and functions, and also based on composing inputs, e.g. interfaces such as attaching, fixing and gluing, as shown as 1910. In step 1912 in FIG. 19, the properties for the one or more component designs are then determined. These include one or both of semantic properties and/or geometric properties as shown as 1914. Finally, in order to determine the representation of the one or more component designs, 1918, the process may involve determining particular constraining inputs through manual, semi-automatic or fully automated means as shown in step 1916.

Aspects and/or embodiments may be provided using a learned approach, such as through the use of machine learning.

Machine learning is the field of study where a computer or computers learn to perform classes of tasks using the feedback generated from the experience or data gathered that the machine learning process acquires during computer performance of those tasks.

Typically, machine learning can be broadly classed as supervised and unsupervised approaches, although there are particular approaches such as reinforcement learning and semi-supervised learning which have special rules, techniques and/or approaches. Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets. Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled. For unsupervised machine learning, there is a range of possible applications such as, for example, the application of computer vision techniques to image processing or video enhancement. Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships. When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

Machine learning may be performed through the use of one or more of: a non-linear hierarchical algorithm; neural network; convolutional neural network; recurrent neural network; long short-term memory network; multi-dimensional convolutional network; a memory network; fully convolutional network or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of frames, as the algorithm maintains some sort of state or memory of the changes in motion. This can additionally result in a reduction of error rates.

Developing a machine learning system typically consists of two stages: (1) training and (2) production. During the training the parameters of the machine learning model are iteratively changed to optimise a particular learning objective, known as the objective function or the loss. Once the model is trained, it can be used in production, where the model takes in an input and produces an output using the trained parameters.

During training stage of neural networks, verified inputs are provided, and hence it is possible to compare the neural network's calculated output to then the correct the network is need be. An error term or loss function for each node in neural network can be established, and the weights adjusted, so that future outputs are closer to an expected result. Backpropagation techniques can also be used in the training schedule for the or each neural network.

The model can be trained using backpropagation and forward pass through the network. The loss function is an objective that can be minimised, it is a measurement between the target value and the model's output.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa.

Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

What is claimed is:

1. A method for determining an architecture comprising a plurality of properties for one or more component designs, the method comprising the steps of:
receiving one or more inputs relating to each of the one or more component designs;
determining characteristics of the plurality of properties for the one or more component designs based on the one or more inputs;
determining one or more constraints for each of the plurality of properties based on the determined characteristics;
determining one or more relationships between the characteristics of the plurality of properties and the determined one or more constraints; and
generating an output architecture.

2. The method of claim 1 wherein the plurality of properties defines one or more semantic properties and one or more geometric properties.

3. The method of claim 1 wherein the one or more component designs comprises any one or more of: schema; architecture; and/or output design.

4. The method of claim 1 wherein the one or more inputs comprises one or more semantic and/or geometric inputs comprising any one or more of: architectural inputs; composing inputs; relational inputs; and/or constraining inputs;
wherein the one or more relationships is further determined based on the architectural inputs and the composing inputs; optionally wherein the one or more relationships comprise semantic and/or geometric relationships;
wherein the architectural inputs comprise any one or a combination of: primitives, pre-determined architectures; newly defined architectures; architecture functions; geometry; and/or a bounding function;
wherein the composing inputs comprise one or more interfaces between the one or more component designs; optionally wherein the one or more interfaces comprises any one or more of: attaching; fixing; bolting; clipping; gluing; rotating; supporting; welding; clearing; fitting; sliding; contacting; relative or absolute positioning; limiting movement in one or more degrees of freedom; enabling movement in one or more degrees of freedom; torque transfer; force loading; magnetic coupling; meshing; spacing; friction; piping; connecting; linking; heat transfer; pressure flow; and/or flow;
wherein the constraining inputs comprise any one or more constraint values relating to each of the one or more component designs; optionally comprising data; regulations; objective functions; geometry; special relationships; manufacturing constraints; design constraints; rules of thumb; and/or values; and
wherein the one or more semantic inputs comprise any or any combination of: heat transfer; flow models; chemical models; aero-driven models; and/or stress/structural driven models.

5. (canceled)

6. (canceled)

7. (canceled)

8. (canceled)

9. (canceled)

10. The method of claim 1 wherein the characteristics of the plurality properties comprise any one or more of semantic and/or one or more geometric characteristics.

11. The method of claim 1 wherein the one or more constraints comprise any one or more constraint values relating to each of the one or more component designs; optionally comprising data; regulations; objective functions; geometry; special relationships; manufacturing constraints; design constraints; rules of thumb; and/or values.

12. The method of claim 1 wherein the step of generating the output architecture further comprises a step of determining one or more representations based on the plurality of properties for the one or more component designs;
wherein the one or more representations comprise any or any combination of semantic and/or geometric representations; cost; cost models; CAD models; G-Code; multi-physics; injection moulding; CFD/FE models/data; PLM data; supply chain and/or operational pathlines; factory design and/or flow; vehicle pathlines; assembly instructions; process flow diagrams; process and instrumentation diagram and/or assembly line processes; and
wherein the method further comprises determining one or more adaptations and/or the one or more adjustments of the one or more representations based on any one or more of: change in relation to the one or more semantic properties and/or the one or more geometric properties.

13. (canceled)

14. (canceled)

15. The method of claim 1 further comprising using a learned algorithm and/or model to determine properties.

16. A method for producing a model of a component design and/or a plurality of properties for one or more component designs, comprising:
receiving a plurality of inputs relating to the component design; and
determining at least one semantic property and at least one geometric property of the component design and/or one or more relationships between the one or more inputs for the one or more component designs; wherein the plurality of inputs comprises at least one model of a component design; and wherein the method further comprises determining at least one interface operable to interface with other designs.

17. (canceled)

18. (canceled)

19. (canceled)

20. The method of claim 16 wherein the plurality of properties defines one or more semantic properties and one or more geometric properties;
wherein the one or more component designs comprises any one or more of: schema; architecture; and/or output design
wherein the one or more inputs comprise any one or more of: architectural inputs; composing inputs; relational inputs; and/or constraining inputs;
wherein the one or more relationships is determined based on the architectural inputs and the composing inputs; optionally wherein the one or more relationships comprise semantic and/or geometric relationships; wherein the architectural inputs comprise any one or a combination of: primitives, pre-determined architectures; newly defined architectures; architecture functions; geometry; and/or a bounding function;
wherein the composing inputs comprise one or more interfaces between the one or more component designs; optionally wherein the one or more interfaces comprises any one or more of: attaching; fixing; bolting; clipping; gluing; rotating; supporting; welding; clearing; fitting; sliding; contacting; relative or absolute positioning; limiting movement in one or more degrees of freedom; enabling movement in one or more degrees of freedom; torque transfer; force loading; magnetic coupling; meshing; spacing; friction; piping; connecting; linking; heat transfer; pressure flow; and/or flow; and
wherein the constraining inputs comprise any one or more constraint values relating to each of the one or more component designs; optionally comprising data; regulations; objective functions; geometry; special relationships; manufacturing constraints; design constraints; rules of thumb; and/or values.

21. (canceled)

22. (canceled)

23. (canceled)

24. (canceled)

25. (canceled)

26. (canceled)

27. The method of claim 20 further comprising a step of determining one or more representations based on the plurality of properties for the one or more component designs.

28. The method of claim 27 wherein the one or more representations comprise any or any combination of semantic and/or geometric representations; cost; cost models; CAD models; G-Code; multi-physics; injection moulding; CFD/FE models/data; PLM data; supply chain and/or operational pathlines; factory design and/or flow; vehicle pathlines; assembly instructions; process flow diagrams; process and instrumentation diagram and/or assembly line processes.

29. The method of claim 27 further comprising a step of determining one or more adaptations and/or the one or more adjustments of the one or more representations based on any one or more of: change in relation to the one or more semantic properties and/or the one or more geometric properties.

30. The method of claim 16 further comprising using a learned algorithm and/or model to determine properties.

31. The method of claim 1 wherein the characteristics comprise any or any combination of: a variable; and a function.

32. The method of claim 1 wherein the relationships comprise any or any combination of: a variable; and a function.

33. The method of claim 1, wherein complex components are represented by one or more of a plurality of component designs with predetermined relationships.

34. The method of claim 1, wherein the inputs comprise any or any combination of: process inputs; flow-based programming inputs; variables; object types; component types; fit types; ports; interfaces; pre-grouped and configured design components; operating requirements; design elements; relationships between design elements; design element placement information; design element constraints; performance requirements; a plurality of sequential engineering operations; adjustments to existing sequences of engineering operations.

35. (canceled)

36. A computer program product operable to be executed by a computer system and configured to perform the method of claim 1; optionally wherein the computer program product provides a computational framework for producing output designs and/or a visual programming tool operable by a user through a user interface.
